(19) United States
(12) Patent Application Publication
(10) Pub. No.: US 2002/0106951 A1
(43) Pub. Date: Aug. 8, 2002

(54) Bib device for protecting against and channeling fluid spills

(76) Inventor: David Buttars, Salt Lake City, UT (US)

Correspondence Address: ALAN J. HOWARTH, P.O. BOX 1909, SANDY, UT, 84091-1909, US

(21) Appl. No.: 09/778,161

(22) Filed: Feb. 5, 2001

(51) Int. Cl. B32B 27/04; D03D 9/00; D03D 15/00; B32B 5/02

(52) U.S. Cl. 442/6; 442/59; 442/65

(57) ABSTRACT

A moldable bib device for protecting an automotive part from contact with a fluid spill and for channeling a spilled fluid includes a substantially planar wire grid disposed on at least one sheet of a fluid-impervious material. A method for protecting a part from contact with a fluid spill and for channeling a spilled fluid includes placing the bib device over the part to be protected and molding the bib device into a shape configured for protecting the part from a fluid spill and for channeling spilled fluid in the container; and placing the container in a position for receiving the spilled fluid after being channeled by the bib device.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates to channeling and collecting spilled fluids. More particularly, the invention relates to a flexible, non-absorbent device for being draped or molded over parts of an automobile or other similar apparatus for protecting parts of the automobile from fluid spills and for channeling such fluid spills into appropriate containers.

When servicing internal combustion engines in automobiles and other such apparatuses, it is often necessary to remove and replace fluids, such as oil, transmission fluid, antifreeze, power steering fluid, brake fluid, and the like. In removing such used fluids, the fluids will often spill on other parts of the automobile, such as drive shafts, brake lines, axles, and the automobile frame. Such spillage not only results in a messy condition that takes time and effort to clean up, but can result in smoke if such fluid burns when it is heated. This smoke may give the false appearance of a serious problem with the automobile. Further, the spilled fluid may continue to drip over time, giving the false appearance of a fluid leak. In either case, additional time and effort may be required to ascertain the cause of the smoke or dripping fluid. For persons who take their automobiles to an automotive service shop for service, this means lost time for both customers and service personnel. Further, the automotive service shop loses customer confidence and profits for having to correct such problems.

U.S. Pat. No. 5,128,189 to Bartlett describes a “Disposable Mat with Compressible Ridge” for protecting floors and other surfaces against liquid spills. The mat has a top absorbent layer, a bottom liquid-impervious layer, and a compressible ridge about the periphery. The compressible ridge acts as a containment dam for non-absorbed liquids.

U.S. Pat. No. 5,888,604 to Evans discloses a “Foldable Mat for Absorbing Liquids”comprising a multilayered flexible sheet having an absorbent, nonsegmented flexible layer and an absorbent, segmented flexible layer. Spaces are left between the segments to allow folding along the boundaries between segments. The device can be used for mats, wipes, absorbent pads, and the like.

U.S. Pat. No. 4,684,562 to Hartkemeyer describes a “Mat for Absorbing Oil and Other Liquids” comprising a top sheet for absorbing oil or other liquid, an intermediate sheet for also absorbing oil or other liquid, and a liquid-resistant bottom sheet. In a preferred embodiment, the top sheet is composed of cardboard, the intermediate sheet is cork, and the bottom sheet is a foil-backed foam.

U.S. Pat. No. 4,875,537 to Gamatz discloses a “Disposable Oil Absorbent Drip pad Assembly for a Vehicle” adapted to be suspended beneath a vehicle to collect oil, grease, and hydraulic fluids comprising a bottom layer of a metallic screen material, an intermediate layer of insulating material, and a top layer of an oil-absorbing material.

U.S. Pat. No. 5,549,178 to Yuhas teaches an “Oil Absorbent pad” for collecting oil drippings comprising an oil-and water-impervious bottom layer onto which are placed sheets of corrugated cardboard stacked on end to absorb oil. The sheets of corrugated cardboard can be alternated with sheets of foam sponge. In a preferred embodiment of the invention, the bottom layer is a cardboard sheet sealed with an oil and water proofing agent.

U.S. Pat. No. 5,711,402 to Sumpter describes an “Oil Drip Collector” for capturing oil dripping from a vehicle. The apparatus comprises a pan made of a rigid material into which a pad of absorbent material is placed. The absorbent pad has an outer skin made of a mesh material that allows the oil to soak through to the absorbent material.

U.S. Pat. No. 1,231,727 to Gaumont discloses a “Screen for projection” comprising a fabric of filaments with a translucent cementitious substance filling in the intervening spaces between the filaments and a non-transparent material held in and distributed through the cementitious material. The filaments can be made of thread, wire, and the like.

While prior art devices for collecting fluid spills are known and are generally suitable for their limited purposes, they possess certain inherent deficiencies that detract from their overall utility in collecting spilled fluids and/or directing such fluids into appropriate containers. For example, such devices are generally rigid and thus cannot be draped over parts of an automobile, such as a drive shaft, brake line, or the like. This lack of flexibility means that such devices will generally be placed on the floor under the automobile and therefore will not prevent the spilling of fluids onto parts of the automobile. Moreover, this lack of flexibility does not allow for conducting spilled fluids into appropriate containers for storage and/or disposal. Further, such prior art apparatuses are generally absorbent and thus present disposal problems in an of themselves. For example, an oil-absorbing apparatus that contains oil must be disposed of as hazardous waste, not regular waste.

In view of the foregoing, it will be appreciated that a flexible bib device for preventing spillage of such fluids onto parts of the automobile and for directing the flow of such fluids into a container would be a significant advancement in the art. It would be further advantageous to provide a bib that does not absorb spilled fluids such that the bib can be disposed of as regular waste. Still further, it would be advantageous to provide a bib that is disposable such that a fresh bib can be used for each new application.

### BRIEF SUMMARY OF THE INVENTION

It is an object of the present invention to provide a flexible bib device that can be draped or molded over selected parts of an automobile for protecting the selected parts from contact with fluid spills.

It is also an object of the invention to provide a flexible bib device that can be shaped in a selected manner for conducting spilled fluids into appropriate collection containers.

It is another object of the invention to provide a flexible bib device for protecting automobile parts from spills and for conducting spilled fluids into appropriate containers wherein the bib device is nonabsorbent such that the soiled bib device presents no special disposal requirements.

It is still another object of the invention to provide a disposable bib device such that a fresh bib device can be used for each new application.

These and other objects can be addressed by providing a moldable bib device for protecting an automotive part from contact with a fluid spill and for channeling a spilled fluid comprises a substantially planar wire grid disposed on at least one sheet of a fluid-impervious material.

Another embodiment of the invention comprises a method for protecting a part from contact with a fluid spill and for channeling a spilled fluid comprising providing a moldable bib device comprising a substantially planar wire grid disposed on at least one sheet of a fluid-impervious material, placing the bib device over the part to be protected and molding the bib device into a shape configured for protecting the part from a fluid spill and for channeling spilled fluid in the container; and placing the container in a position for receiving the spilled fluid after being channeled by the bib device.

### BRIEF DESCRIPTION OF THE SEVERAL VIEWS OF THE DRAWINGS

FIG. 1 shows a perspective view of an illustrative bib device according to the present invention.

FIG. 2 shows a perspective view of an illustrative bib device draped over an automobile part for protecting the part from contact with a fluid spill and for conducting the spilled fluid into a container.

### DETAILED DESCRIPTION

Before the present bib device for use in protecting against fluid spills and for channeling spilled fluids is disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and“the” include plural referents unless the context clearly dictates otherwise. Thus, for example, reference to “a wire grid” includes reference to two or more of such wire grids, and reference to “a fluid-impervious sheet” includes reference to two or more of such sheets.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

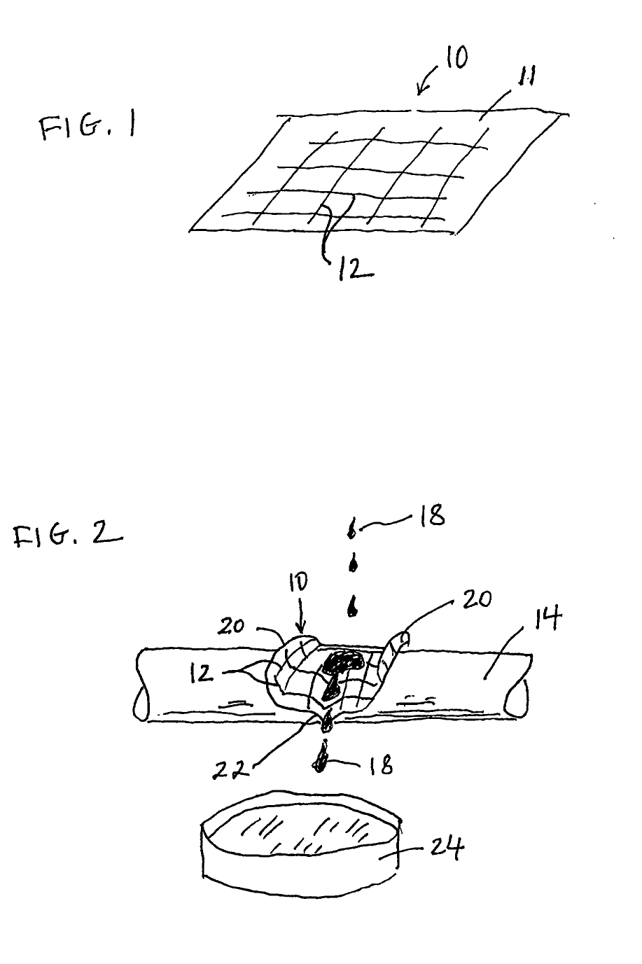

As shown in FIGS. 1 and 2, an illustrative bib device of the present invention comprises a flexible sheet of fluid-impervious material that can be placed over a part of the automobile to prevent unwanted contact of the fluid with parts of the automobile. Preferably, the bib device can be folded or formed into a selected shape so as to direct the flow of the fluid. In a preferred embodiment of the invention the bib device will maintain the selected shape. It is also preferred that the oil bib be disposable such that the oil bib does not need to be cleaned.

FIG. 1 shows a perspective view of an illustrative bib device wherein the bib device is generally rectangular in shape. The shape could also be in any other shape, such as circular, oval, triangular, or the like. The only limitation on the shape of the bib device is functionality. FIG. 1 shows that the illustrative bib device 10 comprises a sheet 11 of nonabsorbent material and a grid 12 of flexible wires. The grid of flexible wires permits the bib device to be formed into a selected shape, such as is shown in FIG. 2, wherein the bib device then keeps its shape for as long as necessary for the particular application. FIG. 2 shows the bib 10 placed over a shaft 14 and shaped to have side baffles 20 and a spout 22 for containing the fluid 18 and directing its flow into a container 24.

In one embodiment of the invention, the grid of flexible wires is sandwiched between layers of fluid-impervious material. The grid of flexible wires and the layers of fluid-impervious material are preferably held together by one or more appropriate adhesives. In this embodiment, either side of the bib device can be used for coming into contact with the fluid. In another illustrative embodiment of the invention, the grid of flexible wires is disposed on a single layer of fluid-impervious material and preferably held in place with an appropriate adhesive. In such an embodiment, the side of the bib containing the wire grid would be placed in contact with the part of the automobile to be protected from spillage and the other side would be permitted to contact the spilled fluid.

The bib device is made by placing the wire grid between sheets of fluid-impervious material and then causing the layers and the grid to adhere to one another, such as with an adhesive. The grid can be either a woven or non-woven grid. An alternative method of making the bib device comprises placing the wire grid on a single layer of fluid-impervious material and then causing the wire grid to adhere to the layer, such as with an adhesive. A preferred material for use as the fluid-impervious material is a waxed paper. Other suitable materials include papers, plastics, and the like.

In a preferred embodiment of the invention, sheets of the bib device are connected together in a long strip and separated by perforations. The long strip is rolled into a roll and stored in a box. A single sheet of the bib device is removed from the roll by tearing at the perforations.

The bib device is used by placing it over a part to be protected from a fluid spill, forming the bib device into a selected shape, such as to contain a fluid spill and conduct the spilled fluid in a selected manner, such as into a container. After the change of fluids is completed and any spills contained and channeled into appropriate containers, then the bib device is removed from its position over the part and is disposed of.

The subject matter claimed is:

1. A moldable bib device for providing protection from contact with a liquid spill and for channeling spilled liquid into a container, the bib device comprising a grid of flexible wire disposed on at least one layer of flexible, liquid-impervious material.

2. The bib device of claim 1 wherein the grid is disposed between two layers of flexible, liquid-impervious material.

3. The bib device of claim 1 wherein the wire grid is adhesively attached to the at least one layer of flexible, liquid-impervious material.

4. The bib device of claim 1 wherein the flexible, liquid-impervious material comprises waxed paper.

5. The bib device of claim 1 wherein the spilled liquid is a member selected from the group consisting of water, oil, transmission fluid, power steering fluid, brake fluid, antifreeze, and mixtures thereof.

6. The bib device of claim 1 wherein the bib device has a shape selected from the group consisting of square, rectangular, circular, oval, and triangular.

7. The bib device of claim 1 wherein the bib device is configured as a strip of sheets and each of said sheets is connected to each adjacent sheet at a line of perforations such that said sheets are separable from adjacent sheets by applying force along such line of perforations.

8. A moldable bib device for providing protection from contact with a liquid spill and for channeling spilled liquid into a container, the bib device comprising a grid of flexible wire disposed between two layers of flexible, liquid-impervious material.

9. The bib device of claim 8 wherein the wire grid is adhesively attached to the two layers of flexible, liquid-impervious material.

10. The bib device of claim 8 wherein the flexible, liquid-impervious material comprises waxed paper.

11. The bib device of claim 8 wherein the spilled liquid is a member selected from the group consisting of water, oil, transmission fluid, power steering fluid, brake fluid, antifreeze, and mixtures thereof.

12. The bib device of claim 8 wherein the bib device has a shape selected from the group consisting of square, rectangular, circular, oval, and triangular.

13. The bib device of claim 8 wherein the bib device is configured as a strip of sheets and each of said sheets is connected to each adjacent sheet at a line of perforations such that said sheets are separable from adjacent sheets by applying force along such line of perforations.

14. A method for protecting a member from contact with a spilled liquid and for channeling the spilled liquid into a container comprising:
(a) providing a moldable bib device comprising a grid of flexible wire disposed on at least one layer of flexible, liquid-impervious material;
(b) placing the bib device over the member to be protected and molding the bib device into a shape configured for protecting the member from the spilled liquid and for channeling the spilled liquid into the container; and
(c) placing the container in a position for receiving the spilled liquid after being channeled by the bib device.

15. The method of claim 14 wherein the grid is disposed between two layers of flexible, liquid-impervious material.

16. The method of claim 14 wherein the grid is adhesively attached to the at least one layer of flexible, liquid-impervious material.

17. The method of claim 14 wherein the flexible, liquid-impervious material comprises waxed paper.

18. The method of claim 14 wherein the spilled liquid is a member selected from the group consisting of water, oil, transmission fluid, brake fluid, antifreeze, and mixtures thereof.

19. The method of claim 14 wherein the bib device has a shape selected from the group consisting of square, rectangular, circular, oval, and triangular.

20. The method of claim 14 wherein the bib device is configured as a strip of sheets and each of said sheets is connected to each adjacent sheet at a line of perforations such that said sheets are separable from adjacent sheets by applying force along such line of perforations.
